(19) United States
(12) Patent Application Publication
(10) Pub. No.: US 2018/0300815 A1
(43) Pub. Date: Oct. 18, 2018

(54) SYSTEM AND METHOD FOR ASSESSING AND RECOVERING INHERENT DIMINISHED VALUE OF A VEHICLE

(71) Applicant: SHIELD GLOBAL PARTNERS, LLC, EVANSVILLE, IN (US)

(72) Inventor: THOMAS WAYNE COLLINS, NEWBURGH, IN (US)

(73) Assignee: SHIELD GLOBAL PARTNERS, LLC, EVANSVILLE, IN (US)

(21) Appl. No.: 15/485,583

(22) Filed: Apr. 12, 2017

(51) Int. Cl. G06Q 40/08; G06Q 30/02

(52) U.S. Cl. CPC G06Q 40/08; G06Q 30/0278

(57) ABSTRACT

A system and method for assessing and recovering inherent diminished value of a vehicle involved in a property loss incident is provided. Inherent diminished value refers to the loss in value of a vehicle that remains after it is completely and professionally repaired. It is the loss of value that results from the simple fact that the vehicle has been in an accident. This type of diminished value is also known as “stigma damage.” The system and method may include obtaining vehicle history data for the vehicle from a computerized vehicle history database based on the vehicle's vehicle identification number (VIN). Based on the vehicle history data, it is determined whether the vehicle has been in an accident resulting in property damage to the vehicle. If it has been determined that the vehicle was involved in a property loss incident, a crash report (i.e. police report) for the vehicle is obtained to determine if a qualified loss has occurred. If a qualified loss has occurred, the inherent diminished value of the vehicle is calculated using a variety of factors. Once the inherent diminished value had been determined, the system and method proceed with initiating action to recover the determined inherent diminished value from a party responsible for the property damage to the vehicle. An assignment of claim from the vehicle owner may also be obtained prior to the step of initiating action to recover the determined inherent diminished value.

### BACKGROUND OF THE INVENTION

### Field of the Invention

The present invention relates to the analysis and use of vehicle historical data. More specifically, the present invention relates to a system and method for using vehicle historical data and other information to assess the inherent diminished value of a vehicle damaged in an accident and subsequently repaired, and to recover that inherent diminished value.

### Description of the Related Art

According to NHTSA, the economic cost of motor vehicle crashes (police reported and unreported) totaled $277 billion in 2010, amounting to almost $897 for every person living in the United States and for 1.9 percent of the U.S. Gross Domestic Product. Property damage costs of $76.2 billion accounted for 28 percent of total economic costs. Property damage costs to vehicles involved in a crash typically fall into one of two categories: (1) total loss, where the cost to repair the vehicle and any additional related expense exceeds, or is expected to exceed the market value of the repaired vehicle, or (2) repairable loss, where it is more cost effective to repair the vehicle than to consider it a total loss and pay out the fair market value of the vehicle. It is the second category that is of interest to the present invention.

When there is a repairable loss, the insurance company of the party at fault will typically be responsible to pay the costs of repair to the mechanical and aesthetic damage to the vehicle to industry standards. Regardless of the quality of the repairs, the stigma associated with the vehicle having been in a crash creates an additional loss of market value to the vehicle reducing its resale value. Had the vehicle not been damaged in an accident, its value would have depreciated normally. As a result, when it comes time for the owner to sell the damaged and repaired vehicle, it will be unable to sell the repaired vehicle for the same price it could have prior to it acquiring an accident history, and may not be able to sell it at all through anticipated resale channels.

“Inherent diminished value” refers to the loss in value of a vehicle that remains after it is completely and professionally repaired. It is the loss of value that results from the simple fact that the vehicle has been in an accident. This type of diminished value is also known as “stigma damage.” Inherent diminution of value exists in newer model motor vehicles involved in accidents due primarily to the ease of access to a vehicle's accident and repair history, using publicly available sources, such as AutoCheck® and Carfax®, as well as disclosure requirements that dealers must adhere to.

Accordingly, there is a need for a system and method for consistently and accurately assessing the inherent diminished value of a repaired vehicle. There is also a need for a system and method for recovering that inherent diminished value from the liable party and/or his/her insurance company.

### SUMMARY OF THE INVENTION

It is therefore an object of the present invention to provide a system and method for consistently and accurately assessing the inherent diminished value of a vehicle involved in a property damage incident.

It is also an object of the invention to provide a system and method for quickly and accurately identifying vehicles involved in a property damage incident and determining whether that vehicle would be appropriate for application of the inherent diminished value analysis and recovery.

A further object of the invention is to provide a system and method for systematically negotiating and recovering the inherent diminished value of a vehicle involved in a property damage incident from the liable party.

The present invention meets these objects by providing a system and method for assessing and recovering the inherent diminished value of a vehicle involved in a property damage incident.

According to one presently preferred embodiment of the invention, there is provided a method for assessing and recovering the inherent diminished value of a vehicle comprising the steps of (1) determining whether the vehicle has been in an accident resulting in property damage to the vehicle by obtaining vehicle history data for the vehicle from a computerized vehicle history database; (2) determining if a qualified loss has occurred for the vehicle if the vehicle has been in an accident resulting in property damage to the vehicle; (3) determining the inherent diminished value of the vehicle if the vehicle is the subject of a qualified loss; and (4) initiating action to recover the determined inherent diminished value from a party responsible for the property damage to the vehicle. The vehicle history data obtained from the computerized vehicle history database may be based on the vehicle's vehicle identification number (VIN). A further step in the process would be obtaining an assignment of claim for the inherent diminished value from the vehicle owner.

The step of initiating action to recover the determined inherent diminished value may further include the steps of: (1) generating a loss data package which includes the determined inherent diminished value; (2) sending said loss data package to a person, or their insurance company, liable for the property damage; and (3) settling the claim and receiving payment for the inherent diminished value loss. The step of generating a loss data package may further include compiling case law in support of the claim for inherent diminished value.

The step of determining if a qualified loss has occurred may further include the following steps: (1) determining whether an owner or lessee of the vehicle was at fault; and (2) determining whether there is collectible insurance as a result of the accident. The steps of determining if a qualified loss has occurred may be determined from data obtained from a crash report that is obtained for the vehicle. The step of determining if a qualified loss has occurred may further include the following additional step or steps: determining whether the vehicle has been involved in any previous accidents involving property damage to the vehicle; determining whether the vehicle is a total loss; and/or determining whether the vehicle was involved in a multi-vehicle accident. If the vehicle is determined to not have been involved in a multi-vehicle accident, the step of determining if a qualified loss has occurred may further include the step of determining whether recovery of inherent diminished value of the vehicle is permitted.

The step of determining the inherent diminished value of the vehicle may further include the steps of: (1) determining the pre-accident market value of the vehicle; and (2) applying a variety of factors to the pre-accident market value to generate a value for the inherent diminished value. The variety of factors may be selected from a group consisting of severity of damage, point of impact, damage to vehicle structure and mileage. The pre-market value of the vehicle may be determined from the VIN and options and is validated by a commercial valuation source. The commercial valuation source may include shared dealer data for pre-sale and post-sale vehicles of the same make and model as the vehicle.

The method for assessing and recovering the inherent diminished value of a vehicle may further include the step of calculating an average diminished value of the vehicle by taking the average value of the inherent diminished value and one or more of a group of industry accepted appraisal methodologies, including comparable analysis, published valuation source analysis and sold auction data.

According to another aspect of the present invention, there is provided a system for assessing and recovering the inherent diminished value of a vehicle. The system includes: (1) a computerized vehicle history database based on the vehicle's vehicle identification number (VIN) for obtaining vehicle history data for the vehicle, including whether the vehicle has been in an accident resulting in property damage to the vehicle; (2) means for obtaining a crash report for the vehicle if it has been determined to have been in an accident; (3) means for determining if a qualified loss has occurred from the data in the crash report; and (4) means for determining the inherent diminished value of the vehicle if the vehicle is the subject of a qualified loss. The system may further include (5) means for initiating action to recover the determined inherent diminished value of the vehicle; and/or (6) an assignment of claim from the vehicle owner.

The means for initiating action to recover the determined inherent diminished value may include a loss data package which includes the determined inherent diminished value. The loss data package may further include one or more items selected from the group consisting of State statutes, case law or legal opinions in support of the claim for inherent diminished value.

The means for determining if a qualified loss has occurred may include a system for determining: (1) whether an owner or lessee of the vehicle was at fault, (2) whether the vehicle is a total loss, (3) whether there is a collectible party as a result of the accident, and/or (4) whether any deadlines to file a claim have passed.

The means for determining the inherent diminished value of the vehicle may include a system for determining the pre-accident market value of the vehicle; and a variety of factors that may be applied to the pre-accident market value to generate a value for the inherent diminished value. The variety of factors may be selected from a group consisting of severity of damage, point of impact, damage to vehicle structure and mileage.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a flow chart showing the primary steps of the method for assessing and recovering the inherent diminished value of a vehicle according to one presently preferred embodiment of the invention.

FIG. 2 is a flow chart showing the sub steps of the VIN Data Processing step shown in FIG. 1 according to one presently preferred embodiment of the invention.

FIG. 3A is a flow chart showing sub steps of the Qualification of Loss for Appraisal step shown in FIG. 1 according to one presently preferred embodiment of the invention.

FIG. 3B is a flow chart showing additional sub steps of the Qualification of Loss for Appraisal step shown in FIG. 1 according to one presently preferred embodiment of the invention.

FIG. 4 is a flow chart showing the sub steps of the Appraisal of Inherent Diminished Value step shown in FIG. 1 according to one presently preferred embodiment of the invention.

FIG. 5A is an example of data resulting from an inherent diminished value calculation using applicant's proprietary method.

FIG. 5B is an example of data resulting from an inherent diminished value calculation using a comparative analysis.

FIG. 5C is an example of data resulting from an inherent diminished value calculation using the Published Valuation Sources Analysis method.

FIG. 6 is a flow chart showing the sub steps of the Loss Notification and Settlement step shown in FIG. 1 according to one presently preferred embodiment of the invention.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

In an insurance context, “diminished value” refers to a vehicle's loss of resale value after it is damaged, even if it is successfully repaired. Even a perfectly repaired vehicle loses value, because future buyers prefer a new or undamaged car over the same model that was previously damaged and repaired. There are three types of diminished value discussed in the insurance industry—immediate, inherent, and repair related diminished value. Immediate Diminished Value is the loss in value that results immediately after an accident before any repairs are made. It is the difference in market value immediately before and after an accident caused by a negligent tortfeasor. In many states, this is the measure of damages for injury to personal property. Inherent Diminished Value is the loss in value of a vehicle that remains after it is completely and professionally repaired. It is the loss of value that results from the simple fact that the vehicle has been in an accident. This type of diminished value is also known as “stigma damage.” Given two identical vehicles available for sale, the one which hasn't been involved in an accident is preferable to the one which has been damaged and repaired. Lastly, Repair-Related Diminished Value refers to the additional loss in value to a vehicle which results from incomplete or poorly-performed repairs. It could include simple cosmetic damages that remain after repair or major mechanical or structural deficiencies. (Also known as, Insurance-Related Diminished Value: This is the loss in value due to improper or less than optimal repairs completed, or inferior parts utilized other than new original equipment manufacturer, (“OEM”), due to insurance company demands for cost savings in the repair process). The present invention concerns a system and method for assessing and recovering the second of these, Inherent Diminished Value (IDV).

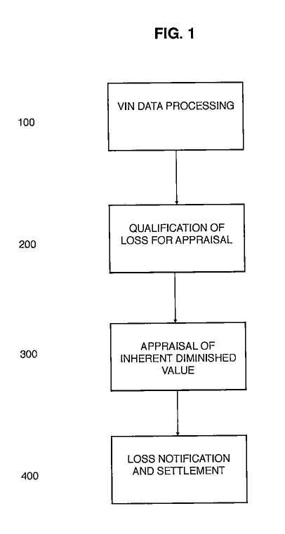

An overview of the method of the present invention is shown in the flowchart depicted in FIG. 1. In step 100, the VIN data for one or more vehicles is gathered, stored and processed. Next, in step 200, the VIN data is reviewed and other factors considered to determine whether the loss qualifies for an appraisal of the inherent diminished value. If the loss is qualified, in step 300, the inherent diminished value is appraised. Finally, in step 400, once the inherent diminished value has been determined, notification and settlement of the loss is initiated.

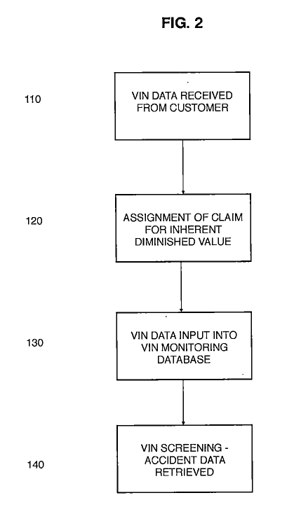

Further elaboration of the VIN data processing step 100 is shown in FIG. 2. For a new fleet client, for example, an agreement is entered into and VIN data for the client's vehicle(s) are provided 110. At this time, the client may enter into an agreement whereby it assigns its claim for the loss to the applicant 120. While FIG. 2 shows this step occurring after the VIN data is received from the customer, it can be done at any time prior to initiation of the loss notification and settlement step 400. Thereafter, on a periodic basis, typically monthly, the client provides a report of VIN data for newly leased vehicles along with term lease data. This lease data in then input into a VIN monitoring database 130, which is then periodically checked to determine whether any vehicle(s) have been involved in an accident. Also included in the periodic update would be information on vehicles that have been retired from service for whatever reason. The VINs for these vehicles can be removed from the database. The VIN monitoring database according to a presently preferred embodiment of the invention is a commercially available database such as AutoCheck® that is updated regularly with event reports from vehicles that may be received from sources such as police reports, the department of motor vehicles, and the like. The VIN numbers in the database are periodically, preferably twice a month, checked in the VIN monitoring database to determine if a crash has been reported 140.

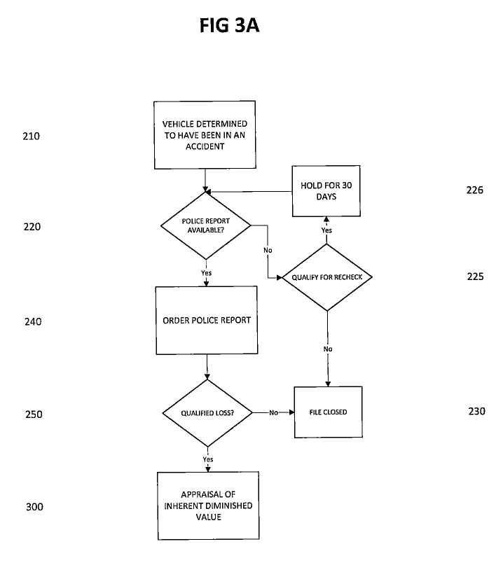

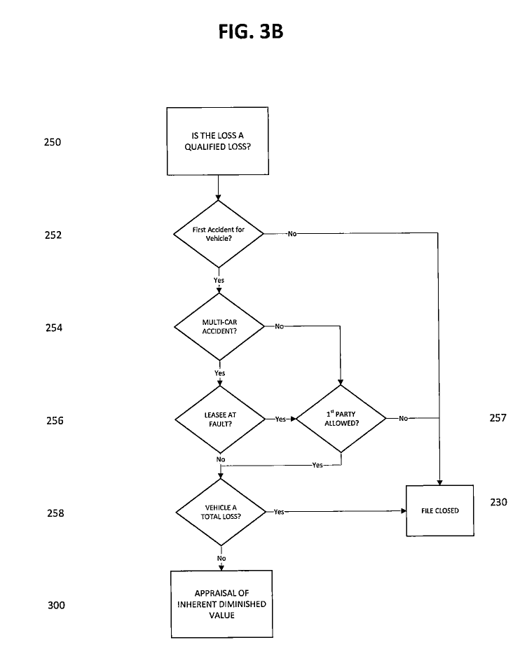

Further elaboration of the qualification of loss for appraisal step 200 is shown in FIG. 3A and FIG. 3B. As best shown in FIG. 3A, if the data from the VIN processing/screening step 100 determines that a vehicle has been in a property loss crash 210, there is a check made to see if a police report or crash report 220 is available for the crash associated with the vehicle. If no crash report is available, it is next determined whether the vehicle qualifies for a recheck 225. This step essentially involved a check of how long the vehicle has been held in the system. Sometimes crash reports may not be immediately available for a vehicle. Thus, if a check determines that a police report is not available, the qualification for recheck looks to see whether the vehicle has been in the system for more than a pre-determined time period, usually six (6) months. If the vehicle has been in the system for less than the pre-determined time period, it is held for another predetermined time period, usually thirty (30) days 226 before again checking to see if a police report is available 220. On the other hand, if the vehicle has been in the system for more than the pre-determined time period at the qualification for recheck 225, the process ends and the file is closed 230.

When a police report or crash report is available, a copy of that police or crash report is obtained from the report providers 240. Once the police report or crash report is received, it is reviewed to determine if there is a qualified loss 250. Several steps may be involved in determining whether the loss is qualified depending on the particular situation and the applicable laws in the state where the accident took place. Some of the critical decisions in whether a loss is qualified according to the preferred embodiment of the invention are shown in FIG. 3B. These steps can be performed in any order and the present invention is not limited to the order of steps shown in FIG. 3B.

A qualified loss does not exist unless this is the first property damage accident for the vehicle 252. Also, in most instances, the accident must have been a multi-vehicle accident 254 in order for there to be a qualified loss. The laws in some states do permit the recovery of inherent diminished value in single vehicle accidents. Insurance claims in such single vehicle accidents are commonly known as First-Party Claims. First Party Claims are claims made by the vehicle owner/policyholder against his or her own insurance company to recover the difference in the value of the vehicle before the collision and value of the vehicle after the damage caused by collision had been repaired. This type of claim is usually governed by contract law and the terms of the insurance policy. When a vehicle is damaged, a policyholder generally expects to be “made whole” by its first-party property insurer, but an insurer is legally responsible only to pay according to the terms of the policy.

Thus, if it is determined that the accident was not a multi-vehicle accident 254, a check is made to see if recovery of inherent diminished value is available for a single vehicle accident 257. Even if recovery of inherent diminished value is permitted for a single vehicle accident, some fleet owners may not wish to pursue claims against their own insurance company. In such cases, that question is also addressed at the step of determining whether recovery is permitted for a single vehicle accident 257. If the law permits recovery of inherent diminished value for single vehicle accidents (Yes at 1st Party Allowed 257) the process proceeds to the next step in the decision tree, which, in the case of FIG. 3B, is determination of whether the vehicle is a total loss 258. If the decision at the 1st Party Allowed Node 257 is no, the file is closed 230.

Next, in the case of a multi-vehicle accident 254, the other party, not lessee, must have been at fault 256, or there is no qualified loss. If the lessee is at fault (Yes at node 256), a check is made to see if recovery of inherent diminished value under such circumstances is also permitted 257. As above, if such recovery is permitted, the process returns to the decision tree, and if it is not, the file is closed. Finally, if the vehicle is a total loss 258, that is, if the vehicle is not repairable, there is no qualified loss. In all instances where there is no qualified loss, the file is closed 230. On the other hand, if all of the qualifications are met, the vehicle enters the appraisal system 300.

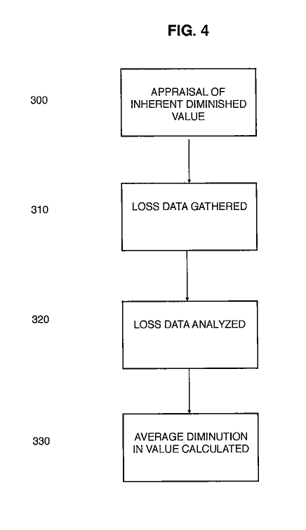

As shown in FIG. 4, after the appraisal system is entered 300, loss data is gathered 310 from the various data sources. The loss data is then analyzed 320, as discussed below, and an average diminution in value is determined 330. The analysis of the loss data 320 and calculation of the average diminution in value 330 according to the present invention begins with the determination of a pre-loss market value of the vehicle in question. This Pre-Loss Market Value is derived from the VIN and options (supplied by the vehicle manufacturer or other third party data source) and is validated by an available published valuation source such the BlueBook®, the regional Black Book®, or the National Association of Automobile Dealers (NADA) Guide. This value is comprised of shared dealer data for pre and post-sale as well as vehicles that have been in an accident vs the same vehicles that have not. The present invention applies various factors to this value (e.g. point of impact and severity of damage) to arrive at the inherent diminished value for the specific vehicle in question. The exact methodology used by the present invention is rules based. For example, if the data reveals that the airbag of a vehicle has been deployed, that may cause the vehicle to be classified as Rough Wholesale (severe damage residual) rather than Average Wholesale (moderate damage residual). That is just one of many factors that are considered in the rules based methodology, which can change depending upon further technological advances in the automobile industry. The methodology itself is used in conjunction with the present invention, but is not necessarily a part of the invention itself. Other appraisal methodologies (similar to 17c or its derivatives) apply an arbitrary cap to the vehicle's pre-accident market value and then reduce the value based on mileage or impact severity. The method of the present invention does not limit evaluations as each vehicle is unique and arbitrary limitations do not accurately reflect the true diminution of value.

Specifically, according to the present invention, determination of the inherent diminished value is a result of averaging the following methodologies, if available:

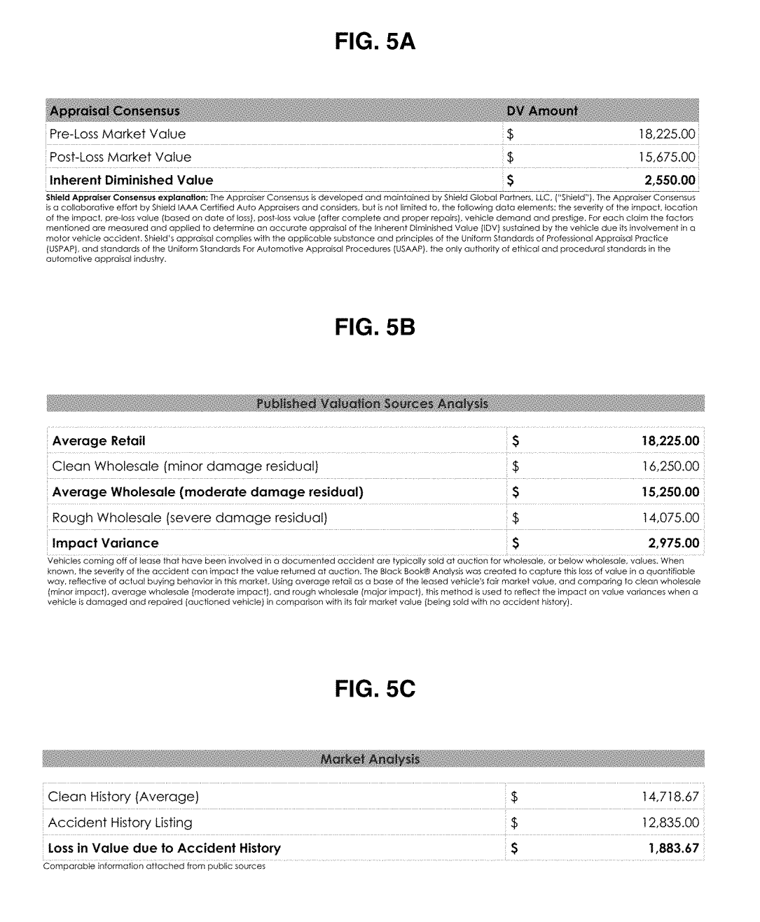

1. Appraisal Consensus—The Appraiser Consensus considers, but is not limited to, the following data elements: the severity of the impact, location of the impact, pre-loss value (based on date of loss), post-loss value (after complete and proper repairs), vehicle demand and prestige. For each claim the factors mentioned are measured and applied to determine an accurate appraisal of the Inherent Diminished Value (IDV) sustained by the vehicle due its involvement in a motor vehicle accident. This appraisal complies with the applicable substance and principles of the Uniform Standards of Professional Appraisal Practice (USPAP), and standards of the Uniform Standards for Automotive Appraisal Procedures (USAAP), the only authority of ethical and procedural standards in the automotive appraisal industry. FIG. 5A shows an example of an Inherent Diminished Value calculated for a particular vehicle using this methodology. The Pre-Loss Market Value is calculated as described in the preceding paragraph, while the Post-Lost Market Value is calculated using applicant's proprietary formula using the factors discussed above in this paragraph.
2. Market Analysis—Comparable information from public sources show that a vehicle involved in an accident has a lower market price than a vehicle with a clean accident history. FIG. 5B shows an example of a Loss in Value due to Accident History calculation. The values shown in FIG. 5B were derived from comparable vehicle advertisements that have been screened to reflect the configuration and history of the subject vehicle. As an example, consider three 2015 GMC Acadia SLTs. The Clean History (Average) was the average price between vehicle 1, a 2015 GMC Acadia SLT with 27,827 miles and no accidents reported ($33,997) and vehicle 2, a 2015 GMC Acadia SLT with 17,338 miles and no accidents reported ($35,915). The Accident History Listing was for vehicle 3, a 2015 GMC Acadia SLT with 15,120 miles, and accident/damage reported ($30,800).
3. Published Valuation Sources Analysis—Vehicles coming off lease that have been involved in a documented accident are typically sold at auction below average wholesale values. When known, the severity of the accident can significantly impact the value returned at auction. The Published Valuation Sources Analysis was created to capture this loss of value in a quantifiable way, reflective of actual buying behavior in this market. Using average retail as a base of the leased vehicle's fair market value, and comparing to clean wholesale (minor impact), average wholesale (moderate impact), and rough wholesale (major impact), this method is used to reflect the impact on value variances when a vehicle is damaged and repaired (auctioned vehicle) in comparison with its fair market value (being sold with no accident history). FIG. 5C shows an example of an Impact Variance calculation using the Published Valuation Sources Analysis. The Average Retail is calculated in the same manner as the Pre-Loss Market Value described above. The Clean Wholesale and Rough Wholesale values are derived from Published Valuation Sources. The Impact Variance is then derived by taking the difference between the Average Retail and Average Wholesale values.

According to the present invention, a reported or average Inherent Diminished Value is calculated by taking the average of the Inherent Diminished Value, Loss in Value due to Accident History and Impact Variance. In the case of FIGS. 5A-5C, the average Inherent Diminished Value for the 2015 GMC Acadia SLT in question would be $4,673.67.

In addition, Sold Auction Data may be used to calculate IDV. Sold Auction Data will be comprised of up to 90% of the vehicles sold in the auction market. This data is provided by third party providers such as Experian®. The third-party provider screen these VINs and will determine which have been in an accident and which have not. The difference between the values of vehicles that have been in an accident and those that have not are compiled together to create average specific to Year Make and Model.

While there are numerous ways to identify and measure Inherent Diminished Value (IDV), the method of the present invention provides an accurate and logical measurement of IDV that was heretofore unknown which utilizes the culmination of objective data and experts' experience and opinions and, as with any other expert appraisal method, understands that there is a portion of opinion associated with the process.

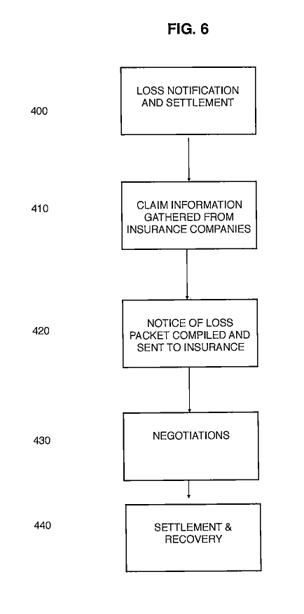

FIG. 6 shows the Loss and Settlement step 400 from FIG. 1 in greater detail. First, claim information is gathered from insurance companies 410. This information includes, but is not limited to: claim number, name of insured, name of insurance company, adjuster name and contact information, date of loss, VIN's for vehicles involved, acknowledgement of liability, etc. Next, a Notification of Loss (NOL) packet is compiled and sent to the insurance company of the at fault driver 420. The NOL packet typically includes, but is not limited to: a demand letter, a copy of the assignment of claim for damages from the client, documentation on vehicle ownership, an Inherent Diminished Value Demand and Evaluation Support, and an Inherent Diminished Value Appraisal with supporting documentation. Once the NOL packet is received, Negotiations 430 ensue and, ultimately, Settlement and Recovery 440 from the liable party or their insurance company.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

We claim:

1. A method for assessing and recovering an inherent diminished value of a vehicle comprising the steps of:
determining whether the vehicle has been in an accident resulting in property damage to the vehicle by obtaining vehicle history data for the vehicle from a computerized vehicle history database;
determining if a qualified loss has occurred for the vehicle if the vehicle has been in an accident resulting in property damage to the vehicle;
determining the inherent diminished value of the vehicle if the vehicle is the subject of a qualified loss; and
initiating action to recover the determined inherent diminished value from a party responsible for the property damage to the vehicle.

2. The method of claim 1 further including the step of obtaining an assignment of claim for the inherent diminished value from the vehicle owner.

3. The method of claim 1 wherein in the step of initiating action to recover the determined inherent diminished value includes:
generating a loss data package which includes the determined inherent diminished value;
sending said loss data package to a party liable for the property damage; and
settling the claim and receiving payment for the inherent diminished value loss.

4. The method of claim 3 wherein the step of generating a loss data package further includes compiling case law in support of the claim for inherent diminished value.

5. The method of claim 1 wherein the step of determining if a qualified loss has occurred includes the following steps:
determining whether an owner/lessee of the vehicle or a third party was at fault; and
determining whether there is collectible insurance as a result of the accident.

6. The method of claim 5 wherein the steps of determining if a qualified loss has occurred are determined from data obtained from a crash report that is obtained for the vehicle.

7. The method of claim 5 wherein the step of determining if a qualified loss has occurred further includes the step of determining whether the vehicle has been involved in any previous accidents involving property damage to the vehicle.

8. The method of claim 5 wherein the step of determining if a qualified loss has occurred further includes the step of determining whether the vehicle is a total loss.

9. The method of claim 5 wherein the step of determining if a qualified loss has occurred further includes the step of determining whether the vehicle was involved in a multi-vehicle accident.

10. The method of claim 9 wherein the step of determining if a qualified loss has occurred further includes the step of determining whether recovery of inherent diminished value of the vehicle is permitted if the vehicle is determined to not have been involved in a multi-vehicle accident.

11. The method of claim 1 wherein the step of determining the inherent diminished value of the vehicle includes the steps of:
determining the pre-accident market value of the vehicle; and
applying a variety of factors to the pre-accident market value to generate a value for the inherent diminished value.

12. The method of claim 11 wherein the variety of factors are selected from a group consisting of severity of damage, point of impact, damage to vehicle structure and mileage.

13. The method of claim 11 wherein the pre-market value of the vehicle is determined from the VIN and options and is validated by a commercial valuation source.

14. The method of claim 13 wherein the commercial valuation source includes shared dealer data for pre-sale and post-sale vehicles of the same make and model as the vehicle.

15. The method of claim 11 further comprising the step of calculating an average diminished value of the vehicle by taking the average value of the inherent diminished value and one or more of a group of industry accepted appraisal methodologies, including comparable analysis, Published Valuation Sources Analysis and sold auction data.

16. The method of claim 1 wherein the vehicle history data obtained from the computerized vehicle history database is based on the vehicle's vehicle identification number (VIN).

17. A system for assessing and recovering the inherent diminished value of a vehicle comprising:
a computerized vehicle history database based on the vehicle's vehicle identification number (VIN) for obtaining vehicle history data for the vehicle, including whether the vehicle has been in an accident resulting in property damage to the vehicle;
means for obtaining a crash report for the vehicle if it has been determined to have been in an accident,
means for determining if a qualified loss has occurred from the data in the crash report; and
means for determining the inherent diminished value of the vehicle if the vehicle is the subject of a qualified loss.

18. The system of claim 17 further comprising means for initiating action to recover the determined inherent diminished value of the vehicle.

19. The system of claim 18 wherein the system further comprises an assignment of claim from the vehicle owner.

20. The system of claim 18 wherein in the means for initiating action to recover the determined inherent diminished value includes a loss data package which includes the determined inherent diminished value.

21. The system of claim 20 wherein the loss data package further includes one or more items selected from the group consisting of State statutes, case law or legal opinions in support of the claim for inherent diminished value.

22. The system of claim 17 wherein the means for determining if a qualified loss has occurred includes a system for determining: whether an owner or lessee of the vehicle was at fault, whether the vehicle is a total loss, whether there is collectible insurance as a result of the accident, and whether any deadlines to file a claim have passed.

23. The system of claim 17 wherein the means for determining the inherent diminished value of the vehicle includes a system for determining the pre-accident market value of the vehicle; and a variety of factors that may be applied to the pre-accident market value to generate a value for the inherent diminished value.

24. The system of claim 23 wherein the variety of factors are selected from a group consisting of severity of damage, point of impact, damage to vehicle structure and mileage.
